(19) United States
(12) Patent Application Publication
(10) Pub. No.: US 2026/0015148 A1
(43) Pub. Date: Jan. 15, 2026

(54) RFID INLAY ASSEMBLY AND CLOSURE CONTAINING SAME

(71) Applicant: Mold-Rite Plastics, LLC, Twinsburg, OH (US)

(72) Inventor: Gareth HUNT, South Hero, VT (US)

(73) Assignee: Mold-Rite Plastics, LLC, Twinsburg, OH (US)

(21) Appl. No.: 19/258,243

(22) Filed: Jul. 2, 2025

Related U.S. Application Data
(60) Provisional application No. 63/669,289, filed on Jul. 10, 2024.

(51) Int. Cl. B65D 77/20; B65D 51/20; G06K 19/07

(52) U.S. Cl. CPC B65D 77/2024; B65D 51/20; G06K 19/0723

(57) ABSTRACT

An RFID Inlay for mounting to closure for a container. The RFID inlay includes a nonconductive substrate with a first induction heating annular ring located on the substrate proximate an outer periphery of the substrate. An RFID antenna is located on the substrate within the inner periphery of the annular ring. An RFID chip is on the first side of the substrate and operatively coupled to the antenna. A method is disclosed for forming the RFID inlay, including forming on a first side of a substrate a conductive layer, the conductive layer having (i) a first induction heating annular ring located proximate the outer periphery of the substrate, the annular ring having an inner periphery; and (ii) an antenna located within the inner periphery of the annular ring; and placing an RFID chip on the first side of the substrate and operatively coupling the RFID chip to the antenna.

### RELATED APPLICATION

This application is related to and claims priority from U.S. Provisional Application No. 63/669,289 filed Jul. 10, 2024, the disclosure of which is incorporated herein by reference in its entirety.

### FIELD OF THE INVENTION

The invention related to a radio frequency identification (RFID) tag assembly and a container closure that includes the RFID assembly.

### BACKGROUND OF THE INVENTION

In recent years, tracking systems have been added to containers in order to detect certain activities related to a container. These are sometimes referred to as electronic article surveillance (EAS). The most common of these used in retail are based on radio frequency technology or magnetic technology. The magnetic technology involves a magnetic tag placed on the outside of the container that can be detected by a detector when the container with the magnetic tag passes in close proximity to the detector and an alarm is activated. The magnetic tag is typically deactivated at the time of checkout so as to permit the customer to pass the detector without tripping an alarm.

Similarly, RFID technology has been used in recent years by applying an RFID tag to the outside of a container. The RFID tag can then be tracked using conventional radio frequency technology. RFID tracking allows a manufacturer, distributor, or retailer to monitor or identify the location of a container at various times throughout the manufacturing or sale process. RFID tags typically include a microchip that can store certain information, The chip is electrically coupled to an antenna. The antenna is configured to receive a signal from a remote transmitter and convey the signal to the microchip. The chip is coded to respond to the signal by transmitting stored information through the antenna to a remote reader.

One of the difficulties with tracking devices located on the outside of a container is the ability for the tracker to be removed, thereby defeating the tracking feature. Locating the tracker inside the container is a better solution.

Several attempts have been made to incorporate an RFID tracker in a container closure, such as a bottle cap. U.S. Pat. No. 7,973,664 and RE46842 disclose two such concepts. The problem with incorporating an RFID tag in a container closure is that it typically needs to be placed in a location where it will not come in contact with the products in the container. In addition, it may be necessary for the products that are in the containers be protected against air and moisture while in the container prior to sale. To achieve that, it is common to use a metallic liner, such an aluminum foil liner, to prevent air permeation. The liner is placed over and sealed to the mouth of the container, thereby preventing air permeation or infiltration. Such liners also act as a tamper evidence seal since access to the contents can only be achieved when the seal is removed or broken, thus providing visual evidence that the contents may have been accessed.

The problem with locating RFID tags in close proximity to a metallic liner is that the metallic liner can deactivate or interfere with the operation of the RFID tag. Also, metallic and other liners are typically attached to the container or closure through use of induction heating to melt a layer of polymeric material in order to secure the liner to the container or the closure. Induced current from Induction heating coil couples into a high frequency RFID antenna coil and can stress the RFID chip by creating conditions where the absolute maximum ratings of the chip are exceeded causing damage to the chip.

A need, therefore, exists for an improved RFID tag assembly for use with a closure.

### SUMMARY OF THE INVENTION

In one embodiment, an RFID Inlay is disclosed for mounting to a closure for a container. The RFID inlay includes a nonconductive substrate having an outer periphery that is substantially the same or slightly larger than an inner surface of the closure so that the substrate is retained by the closure when inserted into the closure. A first induction heating annular ring is located on the substrate proximate the outer periphery of the substrate. The annular ring has an inner periphery. An RFID antenna is located within the inner periphery of the annular ring. An RFID chip on the first side of the substrate and operatively coupled to the antenna, the RFID chip being spaced apart from the first induction heating annular ring.

In an embodiment, the antenna is configured to receive at least one of a high frequency transmission and an ultra-high frequency transmission.

It is contemplated that a second RFID antenna is located on the second side of the substrate from the first RFID antenna. The second RFID antenna is connected to the first RFID antenna through a conductive trace passing through the substrate.

The RFID antenna preferably includes electrical connections to the RFID chip for providing the operative coupling. A capacitor and a resistor may be mounted in series between the electrical connections on the antenna and the RFID chip.

The RFID chip may be programmed to provide at least one of tracking locations of the RFID chip, product information, manufacturer information, a URL code; product encryption keys, or product use information.

In an embodiment the RFID antenna includes two semi-circular ring portions, one located on either side of and connected to the RFID chip. The semi-circular ring portions are tuned to receive a predefined frequency for communicating to the RFID chip.

In an embodiment the antenna is a dipole antenna and the RFID chip and antenna are configured to receive ultra-high frequency (UHF) signals.

It is contemplated that a second conductive annular ring may be formed on the second side of the substrate and located proximate the outer periphery of the substrate and on the opposite side of the substrate from the first conductive annular ring.

In an embodiment, a combination is provided including any of the embodiments of the RFID inlay and a closure, the closure having a top and a skirt extending downward from the top and configured to attach to a container. The RFID inlay is located with the skirt with the first side of the substrate and the first induction heating annular ring, the RFID antenna and the RFID chip being located adjacent to a bottom surface of the closure top.

A method of forming an RFID Inlay for insertion into a closure is provided including the steps of:
receiving a nonconductive substrate, the substrate having an outer periphery that is substantially the same or slightly larger than an inner surface of the closure so that the substrate is retained by the closure when inserted into the closure;
forming on a first side of the substrate a conductive layer, the conductive layer having (i) a first induction heating annular ring located proximate the outer periphery of the substrate, the annular ring having an inner periphery; and (ii) an antenna located within the inner periphery of the annular ring; and
placing an RFID chip on the first side of the substrate and operatively coupling the RFID chip to the antenna, the RFID chip being spaced apart from the first induction heating annular ring.

In an embodiment, the step of forming the conductive layer involves disposing a conductive film over substantially the entire first side of the substate and etching the film to define the first induction heating annular ring and the antenna from the conductive film.

In an embodiment, the first induction heating annular ring Is connected to the antenna through a narrow conductive trace to minimize heat transfer from the outer heating structure to the antenna.

The step of forming the conductive layer may involve disposing conductive material to define the first induction heating annular ring and the antenna through one of a printing, gravure, screen, or inkjet process.

In an embodiment, the conductive layer is an aluminum foil layer.

The substrate is preferably made from polyethylene terephthalate (PET).

In one configuration the RFID chip and antenna receive high frequency (HF) signals or near field communication (NFC), and the antenna is one of either (i) a two portion antenna with a first portion on the first side of the substrate and a second portion on a second side of the substrate and wherein the substrate functions as a dieletric material and along with first portion and second portion of the antenna forms a capacitor of a high pass filter; or (ii) a coil antenna with a conductive bridge. In one embodiment if the antenna is a two portion antenna, the method further comprising the step of placing a foam layer sheet on top of the second portion on the second side of the substrate.

In an embodiment, the method includes the step of forming a second conductive annular ring on a second side of the substrate. The second conductive annular ring is located proximate the outer periphery of the substrate and on the opposite side of the substrate from the first conductive annular ring.

In another embodiment the method involves the further steps of:
receiving a second nonconductive substrate, the second substrate having an outer periphery that is substantially the same or slightly larger than an inner surface of the closure so that the second substrate is retained by the closure when inserted into the closure;
forming on a first side of the second substrate a conductive layer having (i) a second induction heating annular ring located proximate the outer periphery of the second substrate, the second conduction heating annular ring having an inner periphery; and (ii) a second antenna located within the inner periphery of the second induction heating annular ring; and
placing an second RFID chip on the first side of the second substrate and operatively coupling the second RFID chip to the antenna on the second substrate, the second RFID chip being spaced apart from the second induction heating annular ring.

In an embodiment, the method includes the step of placing a foam layer on top of the first side of the substrate after the step of placing the RFID chip on the first side of the substrate.

In an embodiment, the method includes the additional step of providing a non-foil sealing liner having a lidding film layer on one side; the lidding film layer made form material that is configured to melt upon the application of heat.

A method of assembling a closure including an RFID inlay is disclosed. The method includes the steps of:
providing closure having a top and a skirt extending downward from the top, the skirt configured to attach to a container;
receiving an RFID inlay according to any of the embodiments; and
placing the RFID include into the skirt with the first side of the substrate and the first induction heating annular ring, the RFID antenna and the RFID chip being located adjacent to a bottom surface of the closure top.

In one embodiment, a method of assembling a container with a closure including an RFID inlay is disclosed. The method includes the steps of providing a container containing a product that is to be sealed within the container;
providing a closure including an RFID inlay according to any of the embodiments, and a sealing liner;
securing the closure to a neck of the container; and
bringing an induction heating coil in close proximity to a top surface of the closure and activating the induction heating coil to generate heat in the induction heating annular ring causing a bottom surface of the sealing liner to seal on a rim of the neck of the container.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, there are shown in the drawings embodiments that are presently preferred; it being understood, however, that this invention is not limited to the precise arrangements and constructions particularly shown.

FIGS. 1A, 1B and 1C illustrate initial process steps for forming an inlay for a closure or container that includes an RFID tag according to a first embodiment of the invention.

FIGS. 2A, 2B and 2C illustrate subsequent process steps for forming the inlay for a closure or container that includes an RFID tag according to the first embodiment where FIG. 2C shows a completed inlay.

FIG. 2D illustrates an inlay according to another embodiment where an RFID antenna is formed on both sides of a substrate.

FIG. 2E illustrates an embodiment of the invention that includes a stacked arrangement with two different inlays, each having an antenna and RFID chip.

FIG. 3 is a schematic illustration of an RFID tag incorporating an induction protection system such as a high pass filter for protecting an RFID chip.

FIG. 4 is an exploded view of a closure and bottle assembly with an inlay with an RFID tag according to an embodiment of the invention.

FIG. 5 is a cross-sectional view of the assembly of FIG. 4.

FIG. 6 is a cross-sectional view of the closure and bottle of FIG. 4 after the closure is removed from the bottle.

FIG. 7 is an exploded view of another embodiment of an inlay with an RFID tag.

FIG. 8A illustrates an embodiment of an inlay with an RFID tag which includes a fusible link in a foil heating ring with the fusible link shown intact.

FIG. 8B illustrates the an inlay of FIG. 8A after induction sealing with the fusible link shown fractured.

FIG. 9 illustrates the power on tag forward reading calculated from above the antenna.

FIG. 10 is a graphical representation of a 360 degree detection range for an antenna according to an embodiment of the invention.

FIGS. 11A and 11B show the calculated detection ranges from the side and top respectively for the antenna.

FIGS. 12A, 12B and 12C show the analytical results of error testing of the antenna.

FIG. 13 depicts results from testing a prototype antenna showing the range results for top and side for power on tag forward.

FIG. 14 shows the results of the prototype testing for power on tag in reverse.

FIG. 15 shows the calculated range results for the prototype antenna.

### DETAILED DESCRIPTION OF EMBODIMENTS

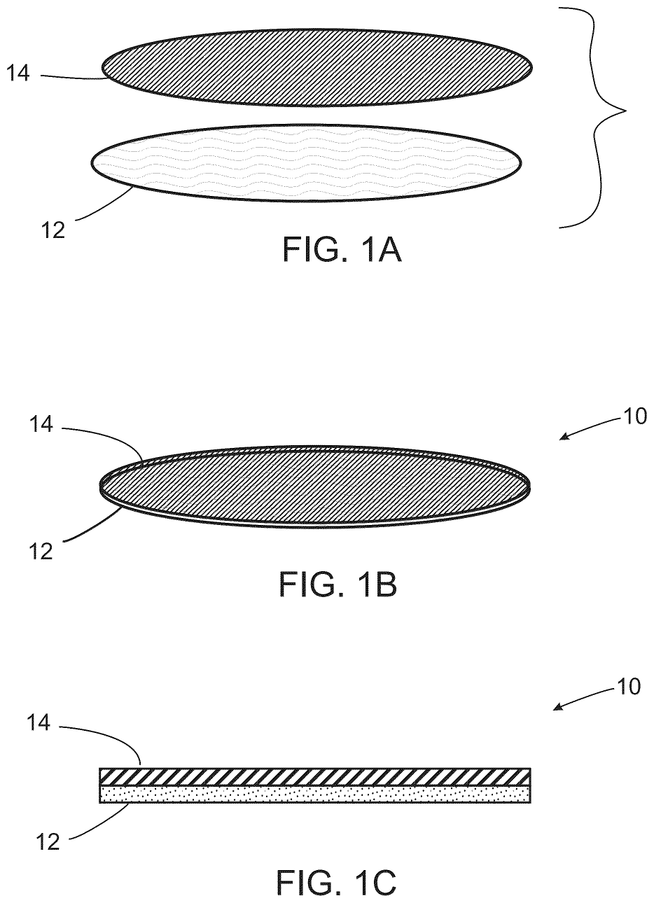

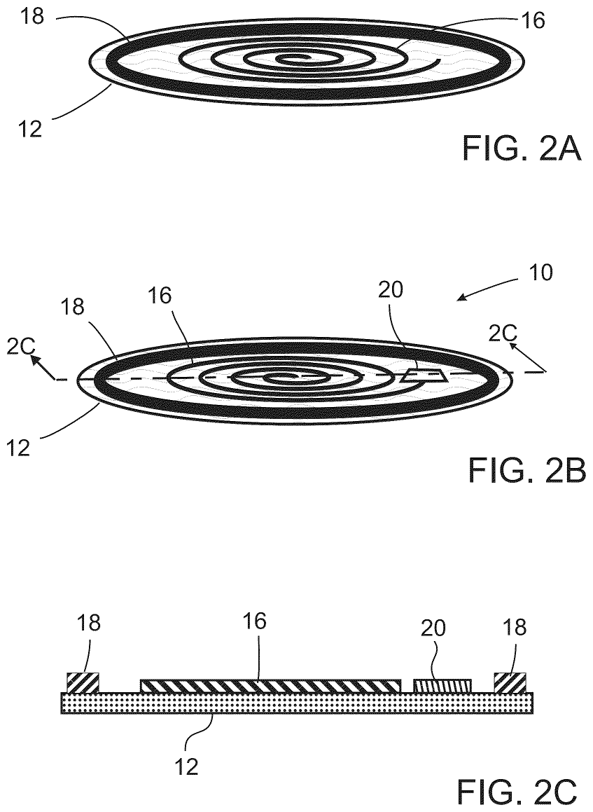

Referring now to FIGS. 1A-1C and 2A-2C, a method of forming an RFID tag on an inlay 10 according to a first embodiment is disclosed. The method involves starting with a nonconductive substrate 12, such as a polyethylene terephthalate (PET) substrate. Other substrates can be used, such as paper of plastic A conductive layer 14, such as an aluminum foil layer, is disposed or formed on the PET substrate. Preferably the foil layer has a thickness of at least about 0.00035 inches. A thicker foil layer is preferable. The desired thickness of the foil layer depends on several factors. As will be discussed below, the conductive layer is used to define or form an induction heating ring and an antenna. As such, the cross-sectional area of the foil layer needs to be chosen such that when formed into a ring it can create sufficient heat to induction seal the inlay to a container while also providing sufficient structure to operate as an RFID antenna.

In one embodiment the conductive layer 14 is formed on one side of the substrate. It is also contemplated that the conductive layer 14 could be formed on both sides of the substrate 12 as will be discussed below. The conductive layer 14 has a sufficient size so that at least some aluminum layer is at a radially outer location. As discussed in more detail below, the outer location where the aluminum extends on the substrate is preferably chosen to be above the rim of the container when the inlay is located on a container. Preferably the conductive layer 14 is substantially the same size as the underlying substrate, although it can be smaller. The conductive layer 14 can be formed by any suitable conventional method. While the conductive material is described as preferably an aluminum foil, it is contemplated that other suitable conductive materials can be used in line with the teachings described herein. FIG. 1C illustrates a cross-section of the conductive layer 14 on the substrate 12.

Referring to FIG. 2A, once the conductive layer 14 is formed on the PET substrate, it is then etched to form an antenna structure 16 located on a radially inward portion of the substrate 12. The antenna 16 is configured to function as an RFID antenna for an RFID tag. The conductive layer 14 is also etched to form at least one outer foil heating structure 18, preferably annular or substantially annular in shape and located radially outward from the antenna 16. The outer foil heating structure 18 is configured to provide a mechanism for effecting attachment of an inner sealing layer or the substrate to a container rim as will be discussed in more detail below. The etching can be achieved by either chemical etching, mechanical etched, or laser etching. Alternatively, the antenna 16 and the outer foil heating structure 18 could be applied to the substrate through a printing, gravure, screen, or inkjet process, in which case the shape of the antenna and heating structure are created as the conductive material is deposited onto the substrate.

An RFID chip 20 is added to the inlay 10 adjacent and electrically connected to the antenna 16, but spaced apart from the outer foil heating structure 18. See FIGS. 2B and 2C. Various types of RFID chips 20 can be used depending on the application. Different RFID chips may require changes to the inlay construction. For example, if the RFID chip 20 is primarily going to be used for traceability, the RFID chip 20 and antenna 16 should be designed to receive ultra-high frequency (UHF) signals. This typically necessitates the use of a dipole antenna. Such antennas can typically be constructed on one side of the inlay 10. It has been determined that for a UHF RFID chip, the outer heating structure 18 could be formed as part of or connected to the antenna 16 through preferably a narrow trace so as to minimize heat transfer from the outer heating structure 18 to the antenna 16.

If the RFID chip and antenna are intended for consumer engagement, such as by bringing a phone into close proximity to the RFID tag to obtain relevant information about the product in the container, that would generally require use of a near field communication (NFC) or high frequency (HF) signal. Such signals generally require either a 2-sided antenna or at least a conductive bridge to complete the coil antenna. As such, in certain embodiments it is contemplated that one or more additional outer foil mounting portions 18A and/or an additional antenna 16A are formed on the opposite side of the substrate 12 as shown in FIG. 2D. In this case, the PET acts as a dielectric material and, thus, can be used along with sections of the antenna on the top and bottom side to form a capacitor of specific capacity to form a high pass filter.

Upon attachment of the RFID chip 20, the inlay 10 is ready for use.

Although not shown, it is contemplated that, to provide the inlay 10 with additional support and to also accommodate structural irregularities in a container rim, a layer of foam 25 could be placed on top of the inlay 10. Alternatively, if the inlay 10 includes a two sided antenna 16, a layer of PET film could be laminated onto the antenna 16 on the bottom side so as to prevent any potential contact between the material in the container and the metal foil antenna 16 or outer foil heating structure 18A. The PET film is selected so as to meet appliable regulatory requirements for the and product in the container.

As will be discussed below, the outer heating structure 18, 18A function to provide an internal heat source for use in sealing an inner seal when the closure is attached to the container. Thus, a dual-sided inlay with outer metallic/conductive mounting portions 18, 18A on both sides increases the amount of conductive material (e.g., aluminum) in the stack-up where sealing is to occur, thereby providing more heat for transfer through conduction to the inner sealing liner or layer. The amount of heat needed will, of course, vary depending on the closure thickness and temperature needed to product induction attachment. As will be discussed below, the inner sealing liner is not laminated to the inlay such that only the conduction seal film/liner remains adhered to the container opening after closure removal. The inlay 10, in turn, remains in the closure.

It is also contemplated that, if desired, the inlay can include two (or more) assemblies of an antenna 16 and RFID chip 20 on a substrate as shown in FIG. 2E. The RFID chips could be activated by different frequencies to transmit different data. For example, one RFID tag can be an HF RFID tag and one could be a UHF RFID tag. It is also contemplated that the RFID chip 20 could be a single dual frequency chip that can accommodate two separate frequency antennas. The two antennas can be formed on one or both sides of the substrate 12.

When using induction, more current flows in the outside edges of the metallic layer. In the present invention, this is advantageous since that is where it is desired to develop heat needed to attach the inlay to the closure and, as will be discussed below, to create sufficient heat to be conducted to the inner sealing liner.

It would be preferable to arrange the induction heat ring(s) 18 so as to minimize generating flux in the antenna 16 and RFID chip 20. However, RFID chips can withstand some level of heating for a short period of time. Also, the foil area in the antenna 16 is preferably reduced as compared to the outer heating structure 18 and separated (radially inward) from that structure. As such, the amount of metal that can be heated by induction is reduced. This, in turn, limits the amount of heat that is applied or conveyed to the RFID chip 20. Even if the outer heating structure is attached to the antenna and RFID chip, such as in a UHF type RFID tag, any connection can be designed to be through relatively thin traces such that the connections from the RFID chip to the antenna and/or outer heating structure 18 would act as a thermal break.

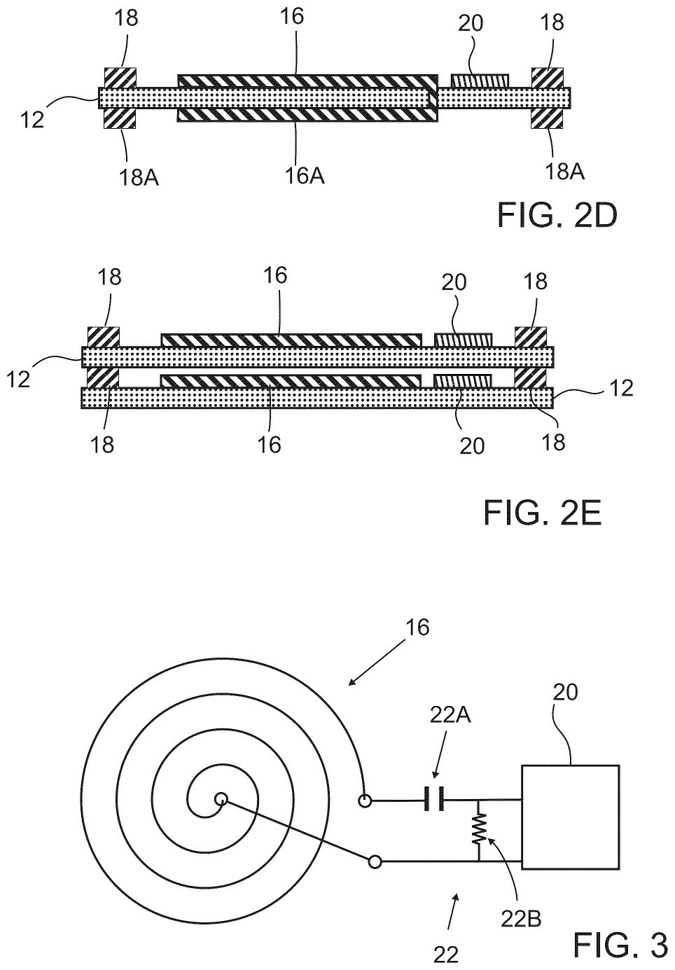

It is also contemplated that, if protection between the RFID chip 20 and the antenna 16 is required, such as in the case of use of an HF RFID tag, a high pass filter 22 can be incorporated, for example by including in series a capacitor 22A and resistor 22B between the antenna connections and the RFID chip 20. Since the frequency of HF RFID tag is much higher than the frequency of the induction seal unit, protection is provided electronically by filtering out the damaging signal from the induction unit coil. Physical shielding or isolation is not required. FIG. 3C illustrates one embodiment of an induction protective configuration.

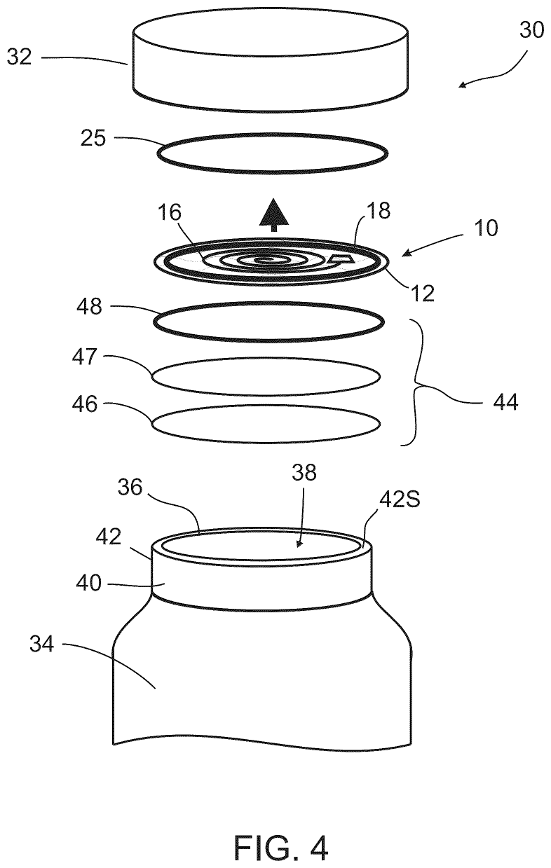

Referring to FIGS. 4-7, one embodiment 30 of an assembly process according to the invention is shown for insertion of the RFID inlay 10 into a closure 32 for attachment to a container 34. The container 34 has an opening 36 for providing access to an interior space 38. The container 34 includes a neck 40 that has a rim 42 with a sealing surface 42S. The closure 32 is configured to engage with the neck 40 of the container 34 for closing off the opening 36. Any conventional engagement mechanisms can be used, such as a reclosable couplings, for example, a threaded coupling, a snap-fit coupling, or a bayonet-type coupling. Alternately, the closure could be attached to the neck of a container in a manner that permits single use closing, e.g., once the closure is removed, it cannot be readily reattached. Still further, the closure could be attached so that it is not readily removeable once placed on the neck of the container. While the closure and the container are illustrated as cylindrical in shape, then can have any suitable shape, depending on the end use.

More specifically, the closure 32 in the illustrated embodiment is a removable cap and includes a top wall 32T, with an outer surface 32T1 and an inner surface 32T2. A sidewall 32S extends downward from the top wall 32T. During the process of assembly, the inlay 10 is inserted into the closure 32 with the side of the inlay that has the outer foil heating structure 18, antenna 16 and RFID chip 20 located closest to the top inner surface 32T2 of the closure and the substrate 12 located on the opposite side as shown in FIG. 4.

As discussed above, it is contemplated to facilitate installation of the inlay 10 into a closure 32 using a closure cap lining machine, the inlay 10 may be laminated to a foam (such as polyethylene (EPE) foam), pulp, plastic film, or other material support layer 25 suitable for carrying the inlay 10 in a lining process. This will provide the stability and compliance necessary to account for surface irregularity of the container lip. The support layer 25 can also as the foam layer discussed above that is positioned between the inlay and the inside of the closure 32.

As will be discussed below, it is contemplated that the inlay 10 is inserted into the closure 32 along with a sealing liner 44 for later application to the container 34. The inlay 10 does not need to be secured to the closure 32. Instead, the friction fit of the inlay 10 against the sidewall 32S of the closure 32 preferably secures the inlay 10 to the closure.

In order to insert the inlay 10 into the closure 32 along with a sealing liner 44, the inlay 10 is preferably fed on a line feeder colinearly with a sealing liner 44. In order for the RFID tag to operate correctly, the present embodiment contemplates that the sealing liner 44 does not include a foil layer, i.e., it is a non-foil sealing liner. Instead, it is a liner material that seals the container through heat conduction, provides sufficient barrier properties and does not reflect or absorb radio waves. Thus, the liner material 44 must include a lidding film layer 46 that is able to melt for attachment to the rim, does not include metal or any other material that reflect or absorb radio waves, and provides the desired barrier protection. The lidding film 46 can be made of various different types of conventional lidding materials, selected based on the contents and the performance of seal, for example a single layer of polypropylene. If the sealing liner requires a moisture and oxygen barrier, it is contemplated that a barrier layer 47 of AIOx (Aluminum Oxide) or metalized Biaxially Oriented Polypropylene (BOPP) film could be formed on or attached to one side of the lidding film (the side facing outward when attached to the container). It has been determined that AIOx and BOPP provide an increased oxygen and moisture barrier while not interfering with the radio waves necessary for the RFID tags to operate.

If additional support is required for the sealing liner 44, a backing layer 48 made from foam (such as polyethylene (EPE) foam), pulp, plastic film, or other material that is non-conductive can be placed on top of the lidding film 46 (or the aluminum oxide layer 47). Sealing liners are well known and, thus, no further discussion is needed. While the backing layer 48 is shown separate from the inlay 10, it is also contemplated that the inlay 10 could be removably attached to the backing layer 48 (such as through a temporary adhesive or wax spot attachments) and fed to the closure.

It is also contemplated that the inlay/foam laminate could also be permanently bonded to the backing layer of the heat seal lidding film such that it does not remain in the cap. This use would be more typical for UHF RFID tag application where it is acceptable for the inlay to be removed when the seal is removed from the product and discarded.

The inlay and sealing liner assembly 44 are inserted into the closure 32 using any conventional insertion process, such as punching the combination into the closure. As discussed above, the sidewall 32S of the closure 32 retains both the inlay 10 and the sealing liner assembly 44 inside the closure.

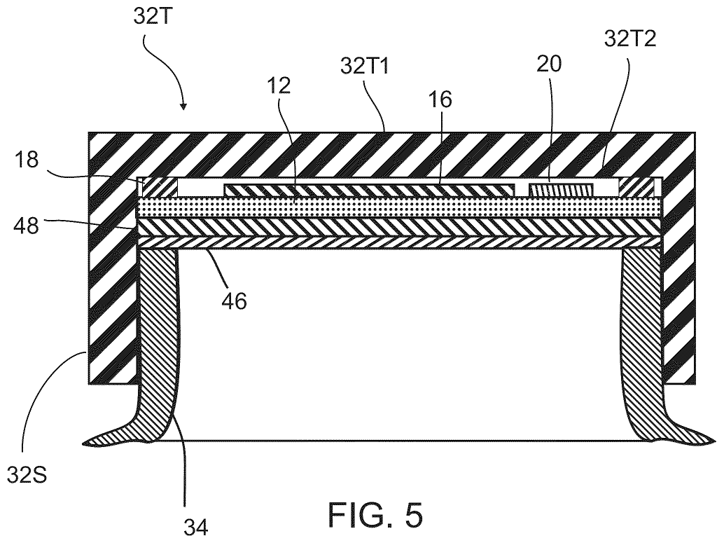

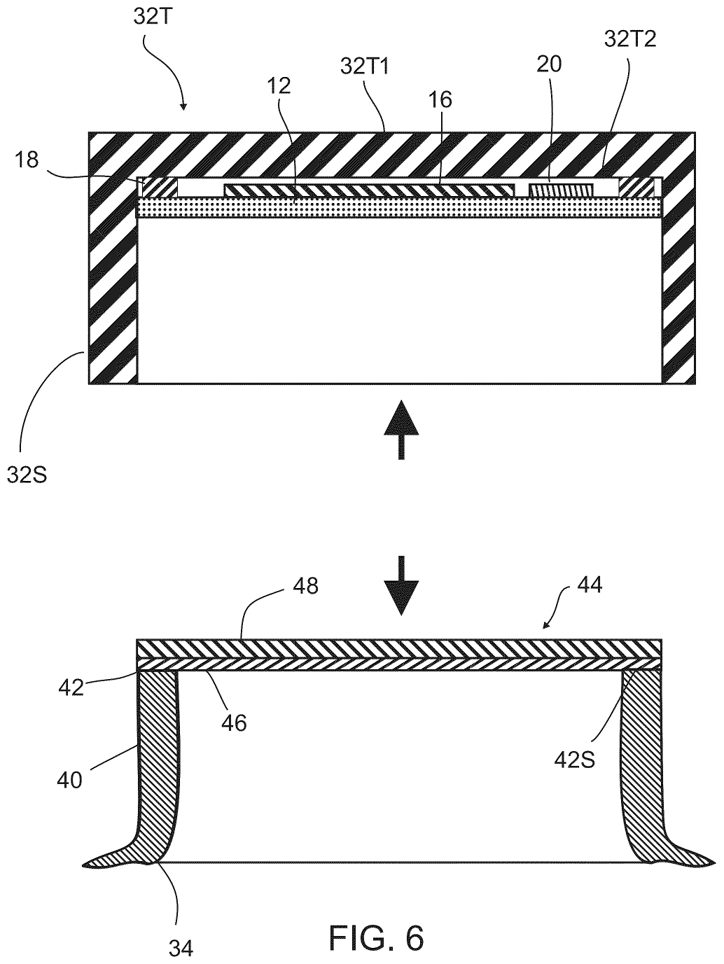

As discussed above, the present invention contemplates that use of an induction heating process to attach the sealing liner assembly 44. More particularly, after the inlay and sealing liner assembly 44 are placed into the closure cap 32, the closure 32 is threaded or attached to the neck 40 of the container 34 with the inlay 10 and sealing liner assembly 44 sandwiched between the inner surface 32T2 and the rim sealing surface 42S as shown in FIG. 5. (For simplicity, the foam or pulp support layer 25 and the barrier layer 47 are not shown in FIGS. 5-6.)

The closure 32 and container assembly 34 are then fed so that the closure 32 is located below or adjacent to an induction heat sealer. The coil in the induction heat sealer is activated which emits an oscillating electromagnetic field. The conductive heating structure 18 heats up as a result of the eddy currents generated in the metallic material. The heat created by the heating structure 18 (and 18A if present) conducts through the backing layer 48 (and any support layer 25) to the sealing liner film 46. The heat from the conduction melts the sealing liner film onto the sealing surface 42S of the rim 42, thereby sealing the opening 36 of the container 34. Since the backing layer 48 is not adhered to the substate 12 (or is only adhered through a temporary adherence as discussed above), when the closure 32 is subsequently removed from the container 34, such as by the customer, the inlay assembly 10 remains in the closure 32 and the backing layer 48 and sealing liner film 46 remain attached to the rim 42 of the container neck 40. See FIG. 6.

Since the RFID chip 20 and antenna 16 are sandwiched between the PET substrate 12 and the inner surface 32T2 of the closure 32, the product in the container 34 will not contact the RFID chip or antenna.

The RFID chip preferably has suitable storage capacity for tracking movement of the closure (and attached container), and can also include other information that may be stored on it, such as the product name, manufacturing or filling date, expiration date, identification number, manufacturer, URL for product information, use or dosage directions, EPC or GS1 codes, etc.

Thus, in one embodiment, the present invention provides a closure 32 that includes a combination inlay 10 with an RFID chip and a sealing liner assembly 44, ready for attachment to a container. The invention uses induction energy to heat up the outer heating structure 18 and then uses conduction of the heat to seal a non-metallic sealing liner or lidding type film.

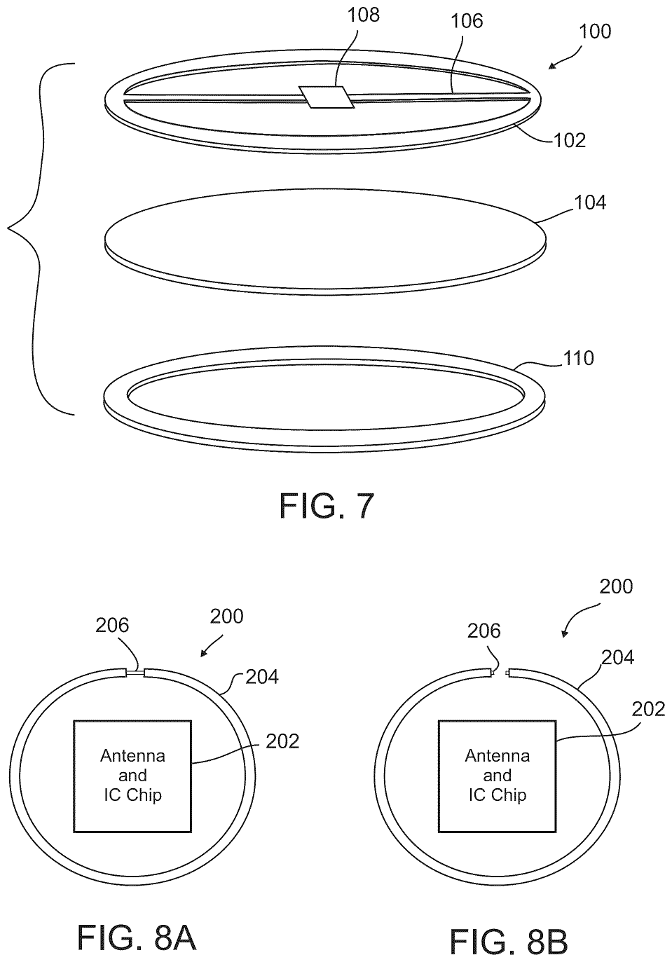

Referring to FIG. 7, an embodiment of an inlay 100 is shown which would be applicable to a UHF antenna. In the illustrated embodiment, the antenna is designed such that it has a contiguous unbroken outer ring 102 of conductive material on a substrate 104. The ring 102 is tuned for the desired frequency response and has connection points or conductive traces 106 to the RFID chip 108 that are connected to the IC antenna terminals on the chip. Since the outer ring 102 is not broken, it allows for induction currents to flow from the induction sealing unit so that the ring will heat up, thus functioning as the conductive heating structure. In addition, since the ring is also tuned to perform as an integral part of the UHF antenna, it provides two functions as part of the inlay 100. The open space inside the ring 102 can be used for an HF antenna or for further tuning and optimization of the UHF antenna.

To improve the induction heating a second layer 110 of foil or other conductive material can be formed on the opposite side of the substrate, again in the shape of a continuous annular ring.

In essence, in the illustrated embodiment, the inlay provides two functions for the induction sealing structure: (i) the foil annulus is designed so that its area will work for induction sealing a sealing liner onto the neck of a bottle, and (ii) the area of the induction heating structure is also used as an integral part of the antenna such that the heating area is the antenna. Further, this invention permits the conductive material to be the antenna in its own right if the closure to be applied does not need to be induction sealed.

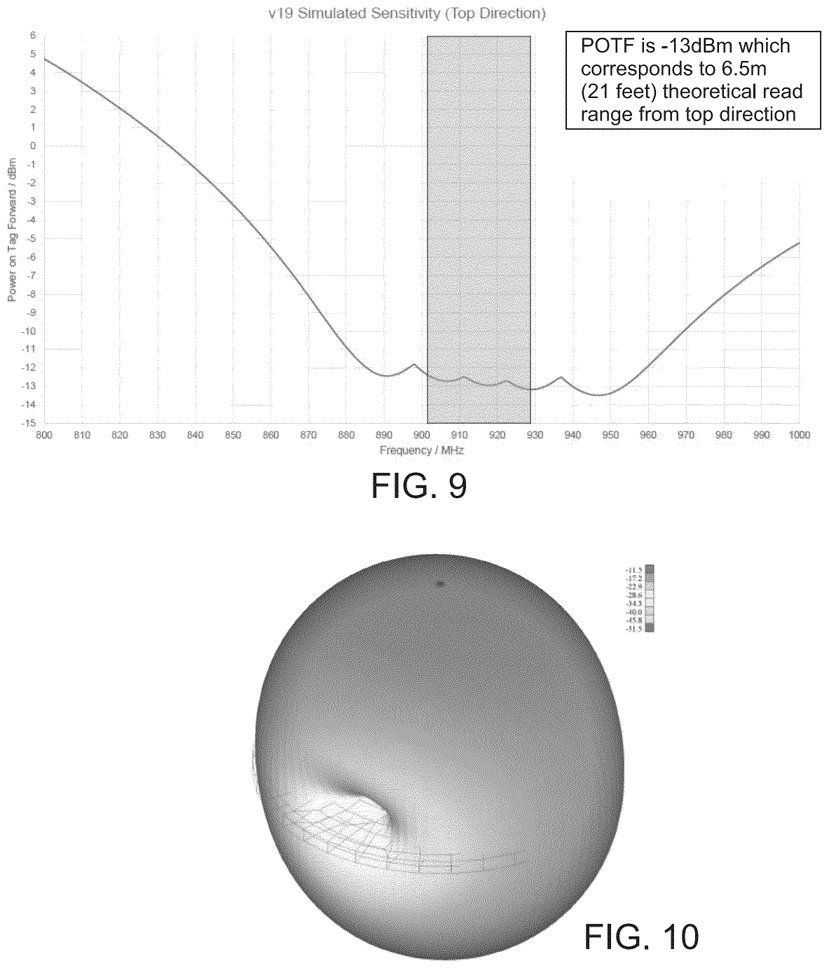

In an embodiment 200 where the RFID antenna 202 is separate from the induction sealing structure 204, i.e., it does not need the induction sealing structure to also function as part of the antenna and is not connected to the annular heating ring, performance of the antenna 202 can be improved by breaking the ring 204 after induction. Referring to FIGS. 8A and 8B, a fusible link 206 or defined reduction in width of the ring 204 can be incorporated. The fusible link or thin section 206 is broken by application of the induction field. Careful design allows for a defined current to break the link. For example a fusible link can be incorporated that is configured to carry 5 amps and that anything above that will result in the link severing. Current is generated in the ring 204 by the induction field causing the ring to heat up. The ring will stop heating when the link is broken. Once broken, the continuity of the ring is severed and, as such, the ring's influence on the RFID signal will be reduced, improving the performance of the RFID antenna 202 that is located inside the ring.

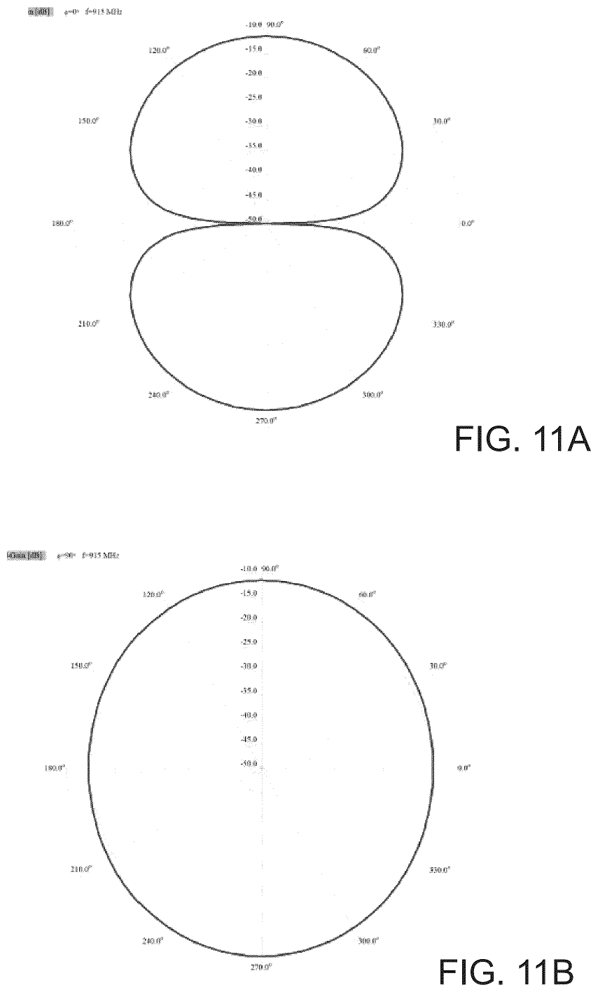

An embodiment of the antenna was analyzed for determining detection range and the effect of the outer metallic ring on the functionality. The thickness of the antenna was 1.5 mm. The desired frequency band for the RFID tags is 902-928 MHz. FIG. 9 illustrates the power on tag forward reading calculated from above the antenna. The result was a calculated range of detection of a signal the antenna of approximately 6.5 m (21 feet).

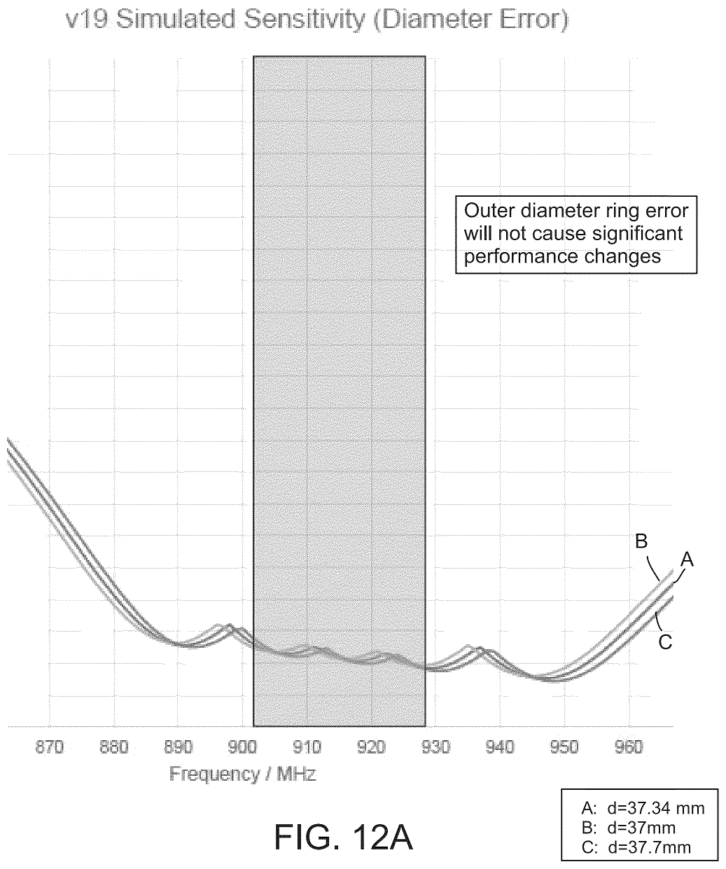

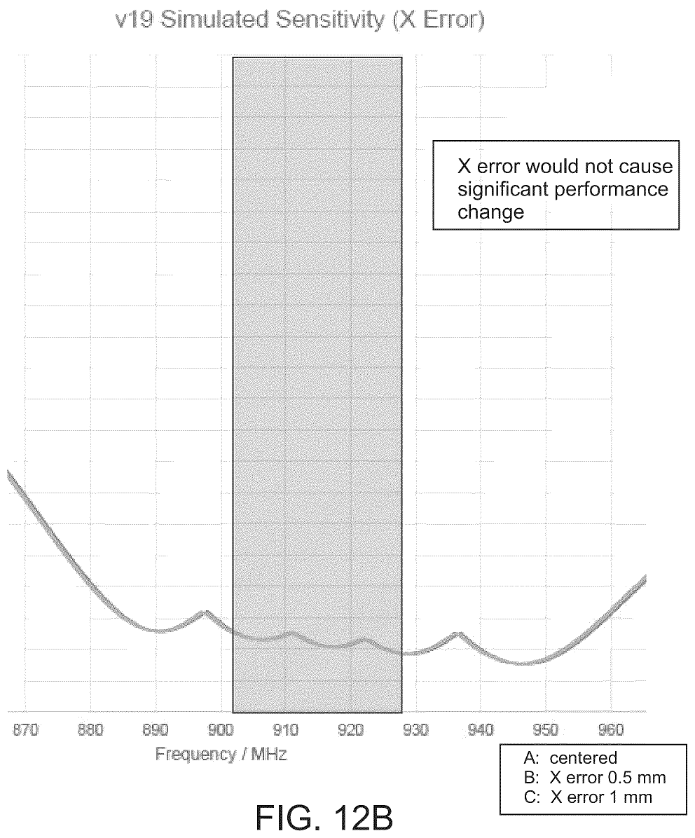

Referring to FIG. 10, a graphical representation is shown of the 360 degrees detection range that would apply to the antenna with the highest detection range being above the antenna. FIGS. 11A and 11B show the calculated detection ranges from the side and top respectively.

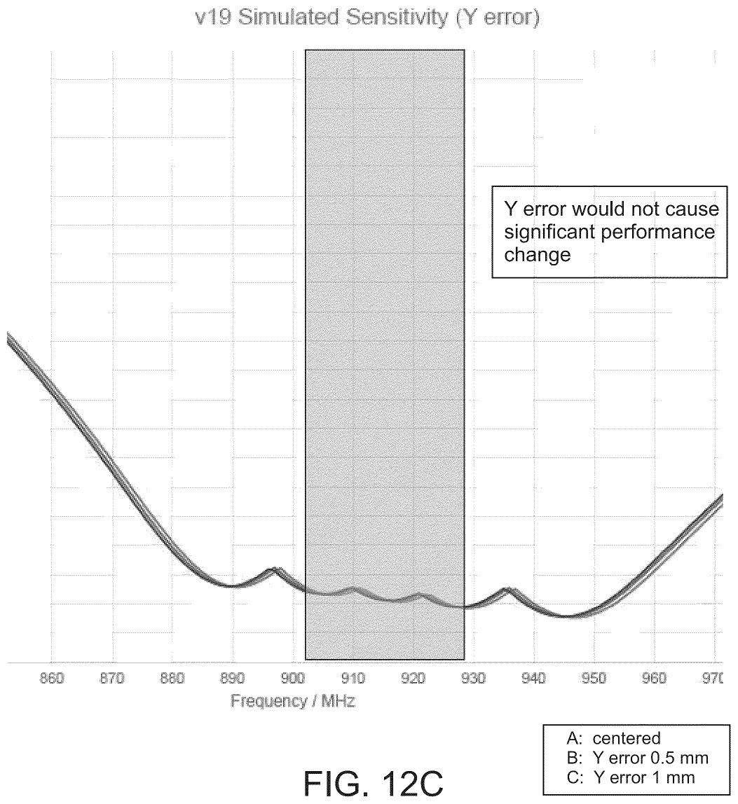

The inventors also analyzed how slight deviations in placement of the antenna relative to the outer conduction ring would impact the antenna performance. FIGS. 12A, 12B and 12C show the analytical results of the error testing.

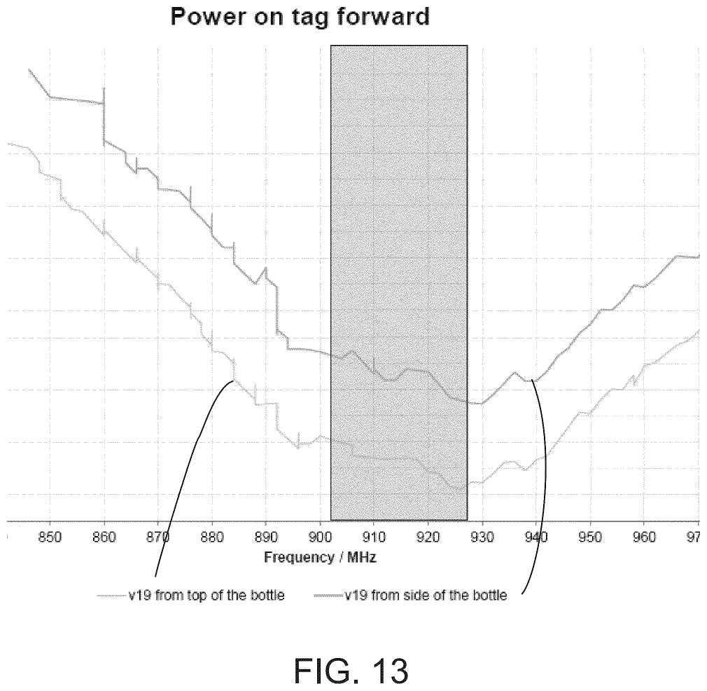

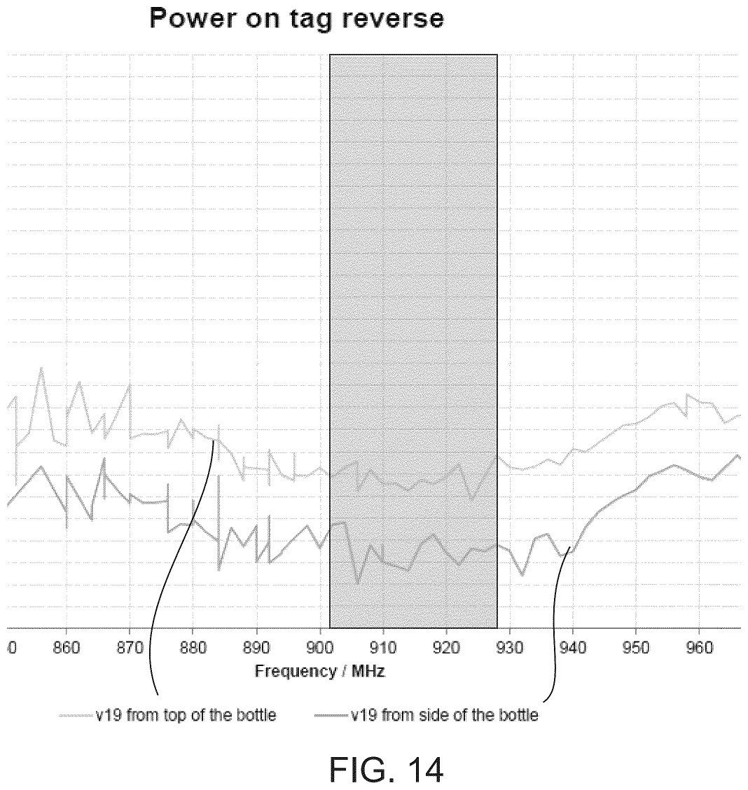

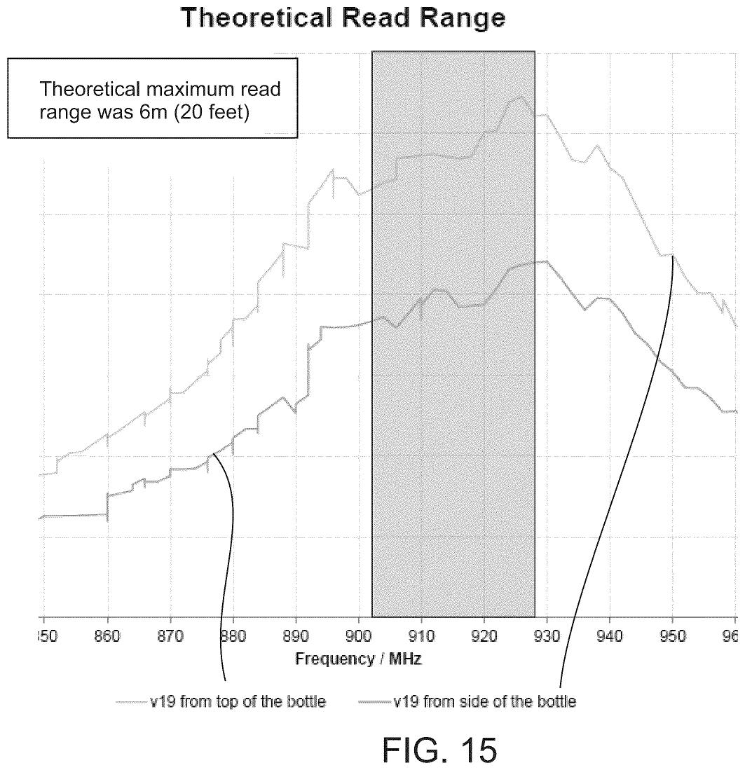

The inventors next tested prototype for confirming the detection range. FIG. 13 depicts the results of the testing showing the range results for top and side for power on tag forward, and FIG. 14 shows the results of the testing showing the range results for top and side for power on tag in reverse. From the power ratings, the inventors were able to confirm the theoretical read distance would be 20 feet above the antenna as depict in FIG. 15.

In the above UHF embodiments, in order to minimize interference from the outer ring it is important that the inner diameter of the outer ring is greater than the outdistance of the antenna. so as to not affect tuning.

It is also contemplated that the present invention can be used to provide electronic tamper evidence. If the chip includes a general purpose I/O or a defined tamper loop, a circuit can be added to the assembly that will electronically provide for tamper detection. That is, if can determine after initially attached to the container, the IC can determine if the closure has been removed from the container and can store that data. A subsequent scan of the RFID chip could provide relevant information, such as when the closure was removed.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

Terms such as “about” or “approximately”, unless otherwise defined or restricted in the specification, should be understood to define a variance of plus or minus 5%-10% to the numerical term referred to.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

1. An RFID Inlay for mounting to closure for a container, the RFID inlay comprising
a nonconductive substrate having a first side and a second side opposite the first side, the substrate having an outer periphery that is substantially the same or slightly larger than an inner surface of the closure so that the substrate is retained by the closure when inserted into the closure;
a first induction heating annular ring on the first side of the substrate proximate the outer periphery of the substrate, the annular ring having an inner periphery;
an RFID antenna on the first side of the substrate with at least a portion of the antenna located within the inner periphery of the annular ring; and
an RFID chip on the first side of the substrate and operatively coupled to the antenna, the RFID chip being spaced apart from the first induction heating annular ring.

2. The RFID inlay according to claim 1, wherein the antenna is configured to receive at least one of a high frequency transmission and an ultra-high frequency transmission.

3. The RFID inlay according to claim 1, wherein there is a second RFID antenna located on the second side of the substrate, the second RFID antenna being connected to the RFID antenna through a conductive trace passing through the substrate.

4. The RFID inlay according to claim 1, wherein the antenna includes electrical connections to the RFID chip for providing the operative coupling, wherein the inlay further comprises a capacitor and a resistor mounted in series between the electrical connections on the antenna and the RFID chip.

5. The RFID inlay according to claim 4, wherein the resistor is either discrete resistor or is created by the internal resistance of the chip; and wherein the capacitor is either a discrete capacitor or capacitance formed by using the top and bottom foil layers and the substrate.

6. The RFID inlay according to claim 1, wherein the RFID chip is programmed to provide at least one of tracking locations of the RFID chip, product information, manufacturer information, product encryption keys, a URL code; or product use information.

7. The RFID inlay according to claim 1, wherein the first induction heating annular ring defines a portion of the antenna and is electrically connected to the portion of the antenna located within the inner periphery of the annular ring; and wherein the annular ring is tuned for the a desired frequency response.

8. The RFID inlay according to claim 1, wherein the antenna is a dipole antenna and wherein the RFID chip and antenna are configured to receive ultra-high frequency (UHF) signals.

9. The RFID inlay according to claim 1, further comprising a second conductive annular ring on the second side of the substrate, the second conductive annular ring being located proximate the outer periphery of the substrate and on the opposite side of the substrate from the first conductive annular ring.

10. In combination, the RFID inlay of claim 1 and a closure, the closure having a top and a skirt extending downward from the top, the skirt configured to attach to a container, wherein the RFID inlay is located with the skirt with the first side of the substrate and the first induction heating annular ring, the RFID antenna and the RFID chip being located adjacent to a bottom surface of the closure top.

11. A method of forming an RFID Inlay for insertion into a closure, the method comprising the steps of:
receiving a nonconductive substrate, the substrate having an outer periphery that is substantially the same or slightly larger than an inner surface of the closure so that the substrate is retained by the closure when inserted into the closure;
forming on a first side of the substrate a conductive layer, the conductive layer having (i) a first induction heating annular ring located proximate the outer periphery of the substrate, the annular ring having an inner periphery; and (ii) an antenna located within the inner periphery of the annular ring; and
placing an RFID chip on the first side of the substrate and operatively coupling the RFID chip to the antenna, the RFID chip being spaced apart from the first induction heating annular ring.

12. The method of forming an RFID Inlay of claim 11, wherein the step of forming the conductive layer involves disposing a conductive film over substantially the entire first side of the substate and etching the film to define the first induction heating annular ring and the antenna from the conductive film.

13. The method of forming an RFID Inlay of claim 12, wherein the first induction heating annular ring Is connected to the antenna through a narrow conductive trace to minimize heat transfer from the outer heating structure to the antenna.

14. The method of forming an RFID Inlay of claim 11, wherein the step of forming the conductive layer involves disposing conductive material to define the first induction heating annular ring and the antenna through one of a printing, gravure, screen, or inkjet process.

15. The method of forming an RFID Inlay of claim 11, wherein the conductive layer is an aluminum foil layer.

16. The method of forming an RFID Inlay of claim 11, wherein the substrate is made from polyethylene terephthalate (PET).

17. The method of forming an RFID Inlay of claim 11, wherein the antenna is a dipole antenna and wherein the RFID chip and antenna are configured to receive ultra-high frequency (UHF) signals.

18. The method of forming an RFID Inlay of claim 11, wherein the RFID chip and antenna are configured to receive high frequency (HF) signals or near field communication (NFC), and wherein the antenna is one of either (i) a two portion antenna with a first portion on the first side of the substrate and a second portion on a second side of the substrate and wherein the substrate functions as a dielectric material and along with first portion and second portion of the antenna forms a capacitor of a high pass filter; or (ii) a coil antenna with a conductive bridge.

19. The method of forming an RFID Inlay of claim 18, wherein if the antenna is a two portion antenna, the method further comprising the step of placing a foam layer sheet on top of the second portion on the second side of the substrate.

20. The method of forming an RFID Inlay of claim 11, further comprising the step of forming a second conductive annular ring on a second side of the substrate, the second conductive annular ring being located proximate the outer periphery of the substrate and on the opposite side of the substrate from the first conductive annular ring.

21. The method of forming an RFID Inlay of claim 11, further comprising the steps of:
receiving a second nonconductive substrate, the second substrate having an outer periphery that is substantially the same or slightly larger than an inner surface of the closure so that the second substrate is retained by the closure when inserted into the closure;
forming on a first side of the second substrate a conductive layer having (i) a second induction heating annular ring located proximate the outer periphery of the second substrate, the second conduction heating annular ring having an inner periphery; and (ii) a second antenna located within the inner periphery of the second induction heating annular ring; and
placing a second RFID chip on the first side of the second substrate and operatively coupling the second RFID chip to the antenna on the second substrate, the second RFID chip being spaced apart from the second induction heating annular ring.

22. The method of forming an RFID Inlay of claim 11, further comprising the step of placing a foam layer on top of the first side of the substrate after the step of placing the RFID chip on the first side of the substrate.

23. The method of forming an RFID Inlay of claim 11, further comprising the step of providing a non-foil sealing liner having a lidding film layer on one side; the lidding film layer made form material that is configured to melt upon the application of heat.

24. A method of assembling a closure including an RFID inlay; the method comprising the steps of:
providing closure having a top and a skirt extending downward from the top, the skirt configured to attach to a container;
receiving an RFID inlay made according to claim 11; and
placing the RFID include into the skirt with the first side of the substrate and the first induction heating annular ring, the RFID antenna and the RFID chip being located adjacent to a bottom surface of the closure top.

25. A method of assembling a container with a closure including an RFID inlay; the method comprising the steps of:
providing a container containing a product that is to be sealed within the container;
providing a closure including an inlay of claim 1 and a sealing liner;
securing the closure to a neck of the container; and
bringing an induction heating coil into close proximity to a top surface of the closure and activating the induction heating coil to generate heat in the induction heating annular ring causing a bottom surface of the inlay to conduct heat to a non-conductive sealing film/liner to seal on a rim of the neck of the container.
